(19) United States
(12) Patent Application Publication
(10) Pub. No.: US 2009/0265940 A1
(43) Pub. Date: Oct. 29, 2009

(54) BLADED SCRAPER

(75) Inventor: Christoph Wahl, Solingen (DE)

Correspondence Address: GROSSMAN, TUCKER, PERREAULT & PFLEGER, PLLC, 55 SOUTH COMMERICAL STREET, MANCHESTER, NH, 03101, US

(73) Assignee: MOZART AG, Solingen (DE)

(21) Appl. No.: 12/443,666

(22) PCT Filed: Sep. 21, 2007
(86) PCT No.: PCT/DE2007/001720

§ 371 Date: Mar. 30, 2009

(30) Foreign Application Priority Data
Sep. 29, 2006 (DE) 10 2006 046 659.4

(51) Int. Cl. A47L 13/08; B26B 29/00

(52) U.S. Cl. 30/169; 15/236.01; 30/320; 30/293

(57) ABSTRACT

The invention concerns a bladed scraper having a blade head which includes a blade receiving means for a blade (K) for cutting an item to be cut in a cutting direction (s), wherein the blade receiving means has a working side from which the blade projects out of the blade receiving means in a working position with a working cutting edge (S) which comes into use. To make working with the bladed scraper safer it is proposed that the bladed scraper has a guide for limiting a cutting movement or cutting region (B) of the bladed scraper and/or for positioning the blade head at an attack angle (β) or in an attack angle range and that the guide is connected to the bladed scraper.

The invention concerns a bladed scraper having a blade head including a blade receiving means having a receiving space for a blade for cutting an item to be cut in a cutting direction, wherein the blade receiving means has a working side from which the blade projects out of the blade receiving means in a working position with a working cutting edge which comes into use. Usually the working cutting edge of the blade in the blade receiving means extends parallel to the working side.

A bladed scraper of the general kind set forth is disclosed for example in DE 199 49 074 A1 and DE 101 51 503 A1. For clean safe cutting a bladed scraper generally requires a particularly sharp blade. To make an operation with the bladed scraper with the blade fitted into the blade receiving means safer, the bladed scraper in accordance with DE 199 49 074 A1 has a blade receiving means with a holding portion which holds the blade fast in the working position and completely covers it in a protection position. Likewise the blade receiving means in DE 101 51 503 A1 is provided with an upper portion which in the working position exposes the working cutting edge, which is put to use, of a blade in the blade receiving means, and completely covers it from a top side in the protection position.

The object of the invention is to provide a bladed scraper of the kind set forth in the opening part of this specification, which permits safer working.

According to the invention the specified object is attained in that the bladed scraper has a guide for limiting a cutting movement or cutting region of the bladed scraper and/or for positioning the blade head at an attack angle or in an attack angle range and that the guide is connected to the bladed scraper.

Safer cutting is possible by means of the guide as certain cutting parameters are adjustable or can be limited. For example, in the case of an automobile laminated glass in which a plurality of layers are joined together, projecting portions have to be cut off at narrow sides, for which purpose the scraper is guided along the narrow sides and in that operation can easily slip off, which adversely affects safe fast working therewith. Here, limiting the cutting region or the cutting movement in the longitudinal direction of the working cutting edge of the blade by means of the guide is helpful, which is described in greater detail hereinafter. Another possible situation of use involves cutting off seams in the case of PVC floor coverings, the strip elements of which are welded at the edges by means of a bead of welding material. In that case the welded seams at their lateral longitudinal edges can generally form a projecting portion in perpendicular relationship to the larger side surface of the floor coverings, which, in order to achieve a floor covering surface which is smooth throughout, must be cut off as completely and smoothly as possible without damaging material in the area around the welded seam. To cut off same, what is referred to as a half-moon knife from the field of saddlery or upholstery craft is generally guided freehand lengthwise over the welded seams, and that requires an extreme degree of skill and expertise on the part of the user. The guide according to the invention can here also limit the cutting region, as is described in greater detail hereinafter, by preventing the bladed scraper in the cutting operation from moving laterally out of or away from the welded seam. In addition the guide can be adapted to hold the blade constantly over the welded seam at an optimum cutting angle in which the projecting portions can be cut off as smoothly as possible and without the knife becoming hooked up in the welded seam. Furthermore the necessary cutting forces should be reduced, inter alia in order to be able more easily to intervene in the cutting operation for correction purposes and to prevent the user from suffering rapid fatigue. In addition, safe supported positioning of the bladed scraper in the cutting region is helpful. Lateral guided support against a laterally upstanding edge, wall, ledge or the like is also possible.

The guide can be integrally connected to the bladed scraper. Preferably the guide is connected to the bladed scraper by means of usual connecting methods such as screwing, riveting, clipping thereto or adhesive. In that respect the preference is preferably for screwing with a conventional screw with countersinkable head as in that way the guide can be more easily interchangeably mounted to the bladed scraper. Thus a guide can be easily replaced by another guide which is suited to the respective purpose of use, or the bladed scraper can be used as a conventional bladed scraper without a guide. A suitable screwing tool can generally be readily available, in a usual working area. In addition the screwing tool can be integratedly storable for example in a handle of the bladed scraper. Preferably the connection between the guide and the bladed scraper can also be implemented by way of latching engagement by means of latching means which engage into or over each other.

The guide can for example limit the cutting region in the cutting direction. An abutment which projects beyond the working cutting edge in the cutting direction can be involved for that purpose. Preferably the guide is designed to limit the cutting region perpendicularly to the cutting direction or in the longitudinal direction of the working side. That is intended to prevent the bladed scraper in use from moving laterally out of a given path, such as the above-mentioned welded seam, in the cutting direction. For that purpose the guide can have an abutment device with at least one respective lateral abutment at both longitudinal sides of the receiving means, the abutments projecting beyond the working cutting edge in the longitudinal direction of the bladed scraper. Thus the abutments can project in or parallel to a plane of the blade in the working position or perpendicularly to the working cutting edge and in the longitudinal direction of the working cutting edge. The abutments can also project beyond the cutting corners, laterally in the longitudinal direction of the working side, to protect lateral end regions of the cutting edges.

In a preferred development of the abutment device it has a flat guide plate with abutment projections as abutments, which laterally delimit a U-shaped notch, wherein the notch in the position of installation of the guide plate in the bladed scraper extends in opposite relationship to the cutting direction at least approximately or exactly to the working side or extends therebeyond. In that configuration the guide plate can desirably be connected to a larger side surface of the blade head, which desirably has a contact surface of correspondingly flat nature, for contact with the guide plate. Such a contact surface is to be found for example in the bladed scraper in accordance with DE 199 49 074 A1 with the side of the blade head, which is the lower side in the working position, in the holding position of the holding portions, which in the holding position is of a configuration involving no projection, that is to say it has no guide projections protruding beyond the underside, and against which the guide plate can preferably be screwed. Preferably the guide plate is adapted to the profile or contour of the contact surface so that it cannot impede operation with the bladed scraper. Thus the abutment projections can project virtually horn-like on the guide plate in the plane of the plate.

The bladed scraper, like that in accordance with DE 10 2005 059 016, can be provided with holding portions for holding the blade in the working position, wherein the holding portions for holding the blade are movable relative to each other into a holding position and the holding portions are connected together by way of a pivot. Preferably there are provided two holding portions, a lower and an upper holding portion, wherein the lower holding portion, as described in greater detail in DE 10 2005 059 016, can have a pivotal opening through which the upper holding portion is pivotable, with a portion which is a rear portion in the cutting direction. Attention is hereby expressly directed to DE 10 2005 059 016 and the disclosure thereof is incorporated into this application. It is preferably provided that a guide arranged above and/or beneath the blade head has a pivotal through opening which is arranged in alignment with the pivotal opening and through which the upper holding portion is pivotable with a portion thereof. Preferably the pivotal opening and the pivotal through opening are of the same profile or the same contour.

The abutment device or the abutments can cover the working cutting edge in the lateral end regions thereof, that is to say in its corner regions or corners, from above and/or from below and/or laterally. In that respect the reference to below is used to mean the side of the bladed scraper which in the working position is towards the item to be cut, while the term above is used to denote the correspondingly remote side of the bladed scraper.

As usual, the working side can extend perpendicularly to the cutting direction, in which case the working cutting edge of an inserted blade extends parallel to the working side. However it is also possible to fit trapezoidal blades into the blade receiving means so that the working cutting edge thereof extends inclinedly relative to the working side. The working side can however also extend inclinedly relative to the cutting direction and the blade can be fitted into the receiving means in such a way that its working cutting edge extends parallel to the working side. A material to be cut can be more easily cut off with the working cutting edge extending inclinedly relative to the cutting direction.

Preferably the guide and in that respect in particular the above-described guide plate are arranged on the bladed scraper at the underside. The guide plate is preferably screwed to the underside or the contact surface of the blade head, with the screw heads preferably being countersunk.

The guide can have a positioning device for positioning the blade head at an attack angle or in an attack angle range. In that way the blade can be held at a given attack angle relative to the item to be cut or relative to the underlying surface, which alone already completely attains the specified object.

In this respect the blade receiving means can have a larger side surface in the form of a contact surface, for contact in respect of a larger side surface of the blade. The contact surface can be arranged at an attack angle which opens in the cutting direction, in relation to an underside attack surface for positioning or contact of the blade scraper on a surface to be worked, of an underlying material. The attack surface can extend in the cutting direction and parallel to the working side. Preferably the attack angle is an acute angle. The attack angle can however also be obtuse, whereby the bladed scraper can be used in a similar manner to a reamer or the like. The attack surface can desirably involve at least the size of the contact surface and/or can be arranged in a region beneath or inclinedly beneath the bladed scraper or the blade head. It can be divided into a plurality of individual surfaces. It is possible in that way to provide for stable support of the blade head against the underlying surface.

Preferably the attack angle is adjustable. For that purpose the attack angle can be adjustable in angle ranges of between 1° and 89°, preferably between 1° and 45° and more preferably between 1° and 30°. The ideal attack angle depends inter alia on the material to be cut in itself and its hardness and brittleness as well as a cutting depth with which the working cutting edge engages into the material to be cut. The attack angle can be altered by the inclination of the attack surface and/or the contact surface being altered. In that case adjustment can be effected steplessly or in steps.

Preferably the positioning device has at least one downwardly pointing extension portion, preferably a downwardly extending guide projection which has the attack surface at its end which faces downwardly in the working position. The position of the working cutting edge in the working position of the bladed scraper can be fixed or variable with respect to the surface of the material to be cut, by way of the height or longitudinal extent of the guide projection. At the same time, a projecting portion of the blade, that is described hereinafter, beyond the attack surface, can be adjusted by way of the longitudinal extent of the guide projections in a downward direction.

For more stable guidance of the bladed scraper, a respective lateral guide projection in the form of a skid having a narrow underside attack surface extending longitudinally in the cutting direction can be provided at both longitudinal side regions of the blade head. Preferably both lateral guide projections are oriented in mutually parallel relationship. By means of the elongated contact surface of the skids in the cutting direction, movement orientation occurs in the cutting direction, as in the case of a conventional slide, which is equivalent to guidance in the cutting direction or guidance in the sliding direction. Thus the specified object is already attained by that measure. Preferably the guide projections are arranged in aligned relationship perpendicularly to the cutting direction, thereby reinforcing a cutting direction dominance. The guide projections can be fixed laterally to the blade head or can integrally adjoin same. Thus the bladed scraper with the skid-like guide projections is of a slide carriage-like configuration with the blade head between the skid-like guide projections and a cutting passage which is elongated in the cutting direction and in which for example the above-described welded seam is passed for smoothing thereof. The guide projections can thus form a supporting means or support for supporting the bladed scraper on the underlying area to be worked. Because of the narrow attack surface, only low levels of frictional force occur between the underlying surface and the attack surface when the skid-like guide projections are involved in a sliding movement. In that way the guide projections, by means of the attack surface associated therewith, can serve as part of the positioning device.

Preferably the guide projections can be arranged at least with a portion which is a rear portion in the cutting direction, in leading relationship with the working cutting edge. In that way, in the above-described operation of cutting off projecting portions of the welded seam, the guide projections can prevent the blade from sliding off laterally or slipping off perpendicularly to the cutting direction, insofar as, with their rear portion, they can bear laterally against the welded seam which has not yet been cut off or planed away and is thus raised or projects above the rest of the floor covering. The guide projections can also serve for laterally limiting the cutting movement or cutting region, insofar as the cutting region is defined by the cutting passage and the guide projections prevent the material which is to be cut from sliding laterally out of the cutting region. For that purpose for example the above-described composite or laminate sheet can be guided with its narrow side through the cutting passage, wherein the guide projections project past the larger side surfaces of the composite or laminate sheet and can thus serve as an abutment to prevent lateral displacement thereof.

Being formed in leading relationship with the working cutting edge in the cutting direction, the guide projections can serve at the same time as an abutment in the cutting direction. In addition, as they can limit or cover the blade at least partially upwardly and/or laterally, they can serve at the same time as a blade protection.

In a development of the bladed scraper the two lateral guide projections can be respectively in the form of a pair of guide projections with a guide projection which is at the front in the cutting direction and a guide projection which is at the rear in the cutting direction, wherein the working cutting edge is arranged in the cutting direction between the front guide projection and the rear guide projection. In another configuration or in addition the lateral guide projections can each have an aligned passage opening which extends parallel to the working edge and into which the blade can project in the working position, with a longitudinal portion of its working cutting edge. Preferably the blade in the working position is so arranged that the working cutting edge is arranged with its ends or corners in the opening.

In a configuration which is preferred as it is a simple one, the blade head can have a body with an underside parallel to the attack surface, a contact surface arranged at the attack angle relative to the underside, and two longitudinal side surfaces which are arranged parallel, perpendicularly to the attack surface and in the cutting direction, to provide the skids or for connection to the skids. Of a substantially prismatic configuration, the body can be produced in the form of an injection die-cast or milled portion.

The outside surfaces of the blade head, in particular its top side and its longitudinal side surfaces or skids, can be at the same time in the form of a handle for ergonomically easy, manual handling. For that purpose the edges can be rounded off and the top side can be curved, adapted to the inside of the palm of the hand of a user. Accordingly a necessary contact pressure for pressing the bladed scraper against the underlying surface to be worked can be produced by bearing with the palm of the hand against the top side, while the fingers can engage the longitudinal side surfaces or the skids. To facilitate the necessary application of force to the bladed scraper, it is possible to provide an anti-slip surface, for example by means of transversely extending grooving and/or by means of an anti-slip surface.

In a preferred configuration of the bladed scraper the guide can have a rolling device with a rolling body which can be rolled in the cutting direction, with running surfaces for support and displacement of the bladed scraper on an underlying surface in and in opposite relationship to the cutting direction. Thus to cut an underlying piece of material, the bladed scraper can be rolled by means of the rolling bodies on the underlying piece of material, in which case the regions or placement points of the running surfaces, with which the rolling bodies respectively bear against the underlying piece of material, define the positioning plane. When the rolling movement is involved, in comparison with a sliding movement, a lower level of forward thrust force is required to move the bladed scraper, which makes operation with the bladed scraper according to the invention safer and more reliable. As a consequence of the predetermined rolling direction in the cutting direction, the bladed scraper is subject to directional dominance in the cutting direction, which is a guidance in the cutting direction. Thus the specified object is already completely attained by that measure.

In order to achieve stable contact for the bladed scraper on the underlying piece of material, three rolling bodies arranged in a triangle are required, wherein preferably two rolling bodies can be arranged in mutually spaced relationship in a longitudinal side region in the cutting direction and one can be arranged in the other longitudinal side region and preferably between the other two rolling bodies in the cutting direction. For reasons of more stable support for the bladed scraper on the underlying piece of material, there can preferably be provided at least four rolling bodies, in which case a rolling body can be arranged in leading relationship in the cutting direction in each longitudinal side region and a rolling body can be arranged in trailing relationship with respect to the working cutting edge in the cutting direction.

If two guide projections are respectively provided with a rear portion and a front portion each of those portions can have a rolling body, in which case they are preferably arranged in a triangle. If the guide projections are in the form of skids, the rolling bodies can be mounted rotatably to the skids and in a rolling position they can project downwardly with their running surfaces. The rolling bodies can generally also be arranged in a waiting position in which they do not project at the underside beyond the attack surface, in which case for use thereof they can be moved out of the waiting position into the running position and can preferably be fixed or latched in both positions. The rolling bodies can also be arranged on any other components of the bladed scraper, such as for example on longitudinal bearers when provided or directly on a body of the blade head.

Preferably the rolling bodies are in the form of rotational cylinders with an axis of rotation perpendicularly to the cutting direction. In this case a diameter of the rotational cylinders is preferably less than a height of the rotational cylinder, whereby guidance for the bladed scraper in the cutting direction is reinforced by the rolling bodies and it is possible to achieve approximately linear support for the bladed scraper, which, as a consequence of the distribution of a support force over a line, can also be more advantageous in terms of the force involved than for example a rather punctiform loading by means of a ball as the rolling body.

It is considered to be a particular advantage if the blade in a readiness position in which the bladed scraper is not applied to an underlying piece of material, projects downwardly by a distance beyond the guide or the attack surface, with its working cutting edge. Downwardly means directed towards the material to be cut and/or the underlying surface, in the cutting operation. Preferably the blade is reciprocatingly displaceable between a storage position in which the blade does not project downwardly by a distance beyond the guide or the attack surface with its working cutting edge, and the readiness position, and can preferably be respectively fixed in the readiness position and the storage position. Preferably the distance is adjustable. At the same time a given thickness of shaving of the material which is to be cut off can be adjusted by way of the magnitude of the distance involved. For that purpose the receiving means and/or the receiving space can be displaceable for example by way of a screw adjustment in the direction towards the attack surface and relative to the attack surface, or, similarly to a conventional hand wood plane, can be fixed by means of wedging in a desired position which permits stepless adjustment. It is also possible to provide a latching detent configuration for stepped adjustment of the distance involved.

In a development of the bladed scraper the blade which in the readiness position projects with its working cutting edge downwardly by the specified distance beyond the attack surface, can be bendable about an axis parallel to the working side, when the attack surface is applied to an underlying surface, and can thus attain a working position. In that way the blade can be torsionally stiffer and more stable in respect of shape during a cutting operation and can thus make the cutting operation more reliable and safer.

In a development of the blade head it can have two blade receiving means for a respective blade, wherein the blade to be used in one blade receiving means faces with its working cutting edge in the cutting direction, and the other blade which is serving as a waiting blade in the other blade receiving means preferably faces with its working cutting edge in opposite relationship to the cutting direction. It is also possible to provide a carousel having a plurality of blade receiving means, a respective one of which is rotatable in the cutting direction and can be fixed therein.

Both blades can be arranged at the same attack angle. Preferably the blade which is in use is mounted at an attack angle which is different from that of the waiting blade. In that case for example the attack angle of the blade in use can be greater than that of the waiting blade. In that case for example in a first operation of cutting off material to be cut, with the blade which is in use, in the cutting direction, a coarse shaving can be cut off while in a second cutting operation with a return movement of the bladed scraper in opposite relationship to the cutting direction, a fine shaving can be cut off with the waiting blade, for smoothing the underlying surface.

The present invention is described in greater detail hereinafter by means of three embodiments by way of example illustrated in a drawing in which:

FIG. 1 shows a side view of a first embodiment of a bladed scraper with guide plate and inserted blade,

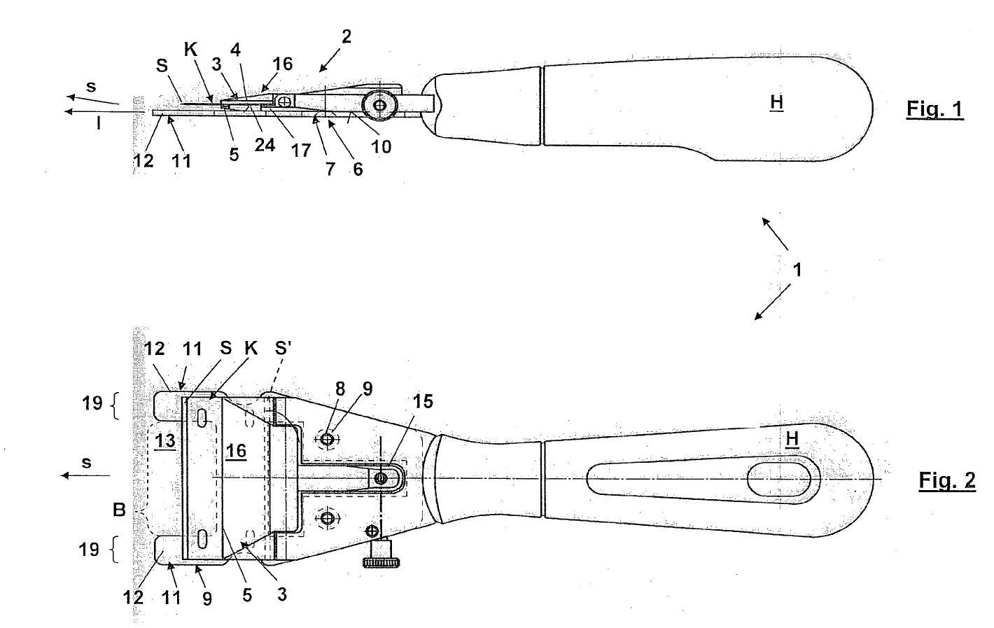

FIG. 2 shows a plan view of the bladed scraper of FIG. 1,

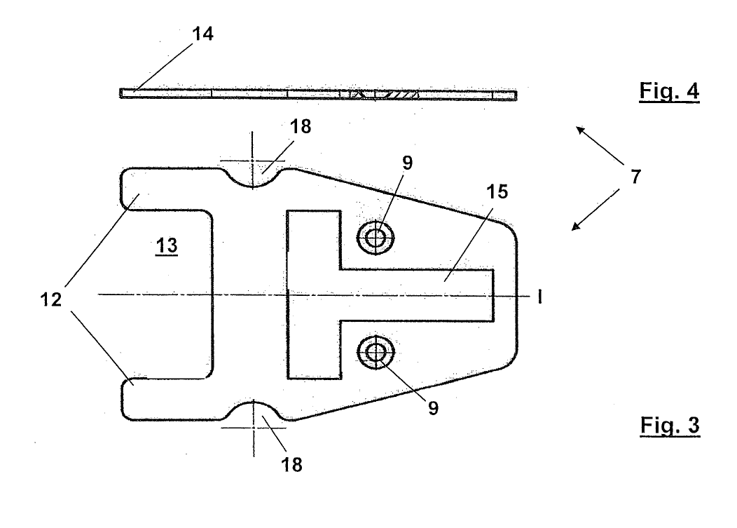

FIG. 3 shows a plan view of the guide plate,

FIG. 4 shows a side view of the guide plate,

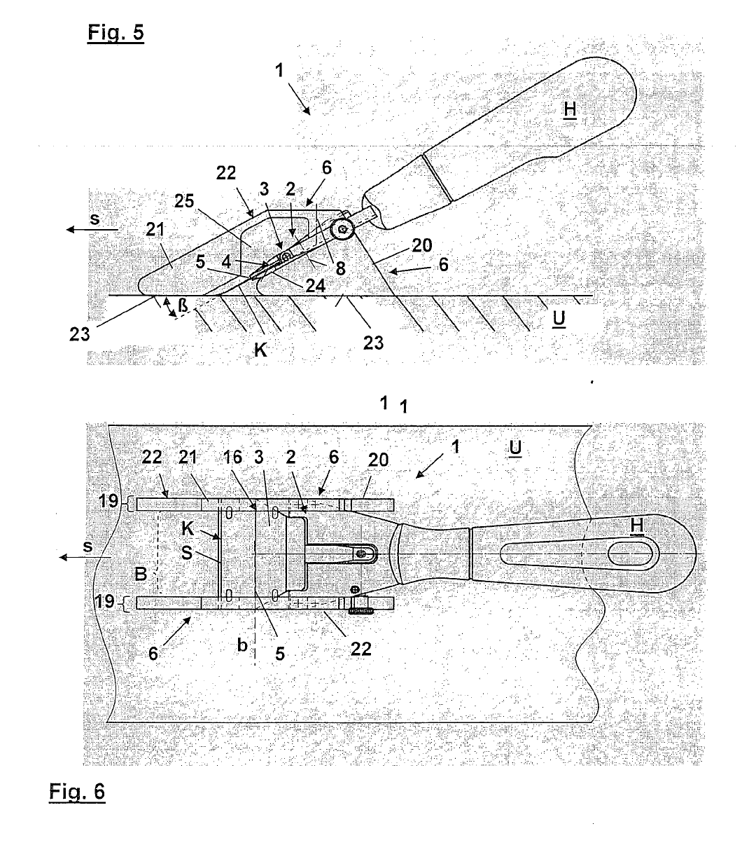

FIG. 5 shows a side view of a second embodiment of the bladed scraper with guide projections and inserted blade and in a position of attack in relation to an underlying surface,

FIG. 6 shows a plan view of the bladed scraper of FIG. 5,

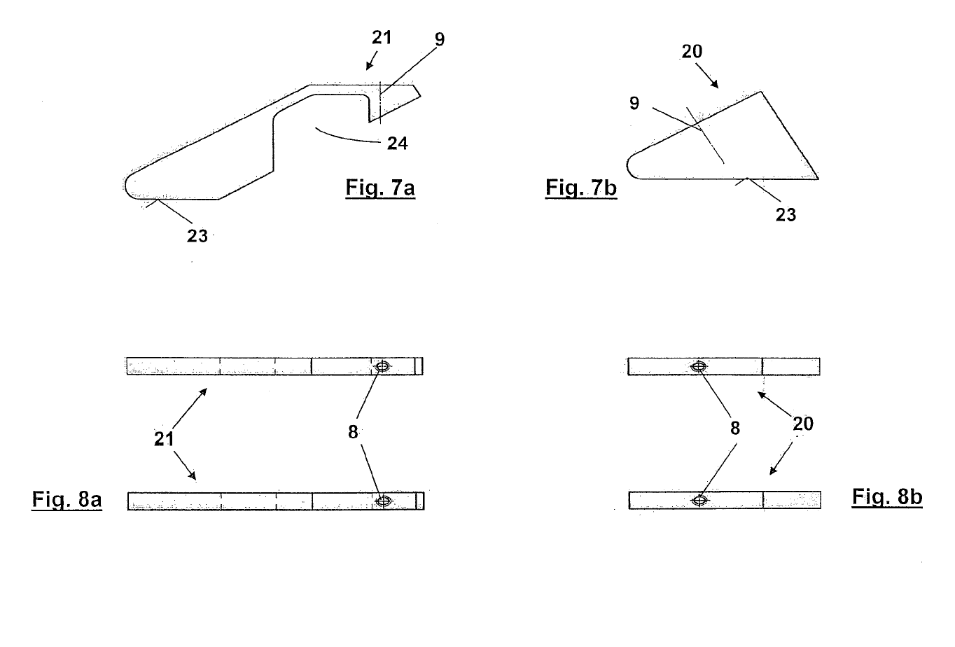

FIGS. 7a and b show a side view of the guide projections,

FIGS. 8a and b show a plan view of the guide projections,

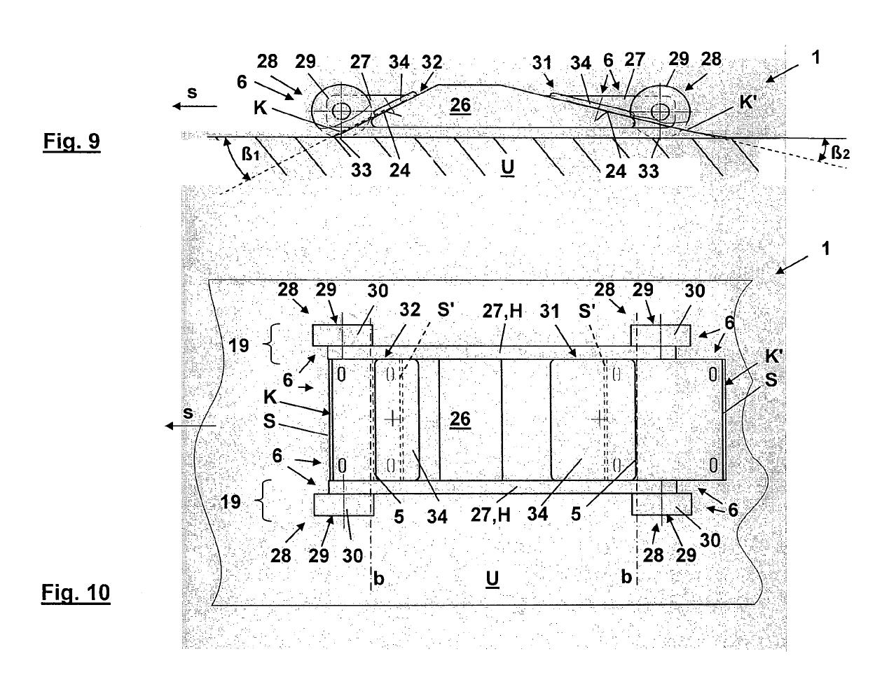

FIG. 9 shows a side view of a third embodiment of the bladed scraper with inserted blade and in a position of attack on an underlying surface, with front portions being omitted, and

FIG. 10 shows a plan view of the bladed scraper of FIG. 9 without front portions being omitted.

FIGS. 1 through 10 show various views and partial views of three embodiments of a bladed scraper 1 with inserted blade K. The bladed scraper 1 has a blade head 2 with a blade receiving means 3. The blade receiving means 3 includes a receiving space 4 for the blade K for cutting an item to be cut which is represented in FIGS. 5, 6, 9 and 10 by an underlying piece of material U, in a cutting direction s. The blade receiving means 3 has a working side 5 which is the rear side in the cutting direction s and from which the blade K projects out of the blade receiving means 3 with a working cutting edge S which comes into operation, in a working position as shown in FIGS. 1, 2, 5, 6, 9 and 10. The working cutting edge S of the blade K in the blade receiving means 3 extends parallel to the working side 5.

According to the invention the bladed scraper 1 has a guide 6 for limiting a cutting movement or a cutting region B (see indicated in FIGS. 2 and 6) of the bladed scraper 1 and/or for positioning the blade head 2 at an attack angle β, β₁, β₂ (see FIGS. 5 and 9). The guide 6 is releasably screwed to the blade head 2 in the first two embodiments of the bladed scraper 1 shown in FIGS. 1 through 8 while in the third embodiment of the bladed scraper 1 as shown in FIGS. 9 and 10 the guide 6 is in part integral and in part releasably connected to the blade head by means of screws.

Except for the guide 6 according to the invention the bladed scraper 1 shown in the first two embodiments is the same by way of example as the bladed scraper which is disclosed in DE 10 2005 059 016 (not yet published at the filing date of this application), in which respect its features described in DE 10 2005 059 016, in particular in regard to the configuration of the blade head 2, are incorporated into the disclosure of this application. The blade head 2 of this bladed scraper 1, at the underside, that is to say, as shown in FIG. 5, at its side which in the working position is towards the underlying material U, has a flat connecting surface 10 for connecting the guide plate 7 to the blade head 2, wherein the guide plate 7 is releasably connected to the blade head 2 by means of screws 8 arranged in countersunk relationship in screw holes 10 in the guide plate 7. There is also a handle H.

It can be seen directly from FIG. 1 that the guide plate 7 is arranged parallel to the blade K or the receiving space 4 on the blade head 2. The guide plate 7, as part of an abutment device 11, has two abutment projections 12 as abutments, wherein the abutment projections 12 are arranged in the plane of the guide plate in the position of installation in parallel relationship with the longitudinal axis I of the bladed scraper 1 forwardly and with a larger directional component in the cutting direction s and laterally define a U-shaped notch 13. In the position of installation of the guide plate 7 the notch 13 extends to close to the working side 5 whereby the cutting edge S of the blade K is exposed in the region of the notch 13. The abutment projections 12 have therearound narrow sides 14 which, depending on the respective use and movement of the bladed scraper 1, serve as abutments for limiting the cutting movement or the cutting region B.

If by way of example a laminated glass sheet (not shown) is cut at its narrow sides and its narrow side is guided between the abutment projections 12 in such a way that the abutment projections 12 bear with their inner, mutually facing narrow sides 14 against the larger side surfaces of the laminated glass pane, upon lateral displacement of the bladed scraper 1, the bladed scraper 1 is held on the narrow side of the laminated glass sheet. In the same manner, when cutting a welded seam, described above but not shown here, of a PVC floor covering, the inner narrow sides 14 of the abutment projections 12 serve as abutments to prevent the bladed scraper 1 from moving perpendicularly to the cutting direction s. The narrow sides 14 of the abutment projections 12, which are at the end in the cutting direction, can operate as abutments to prevent a lifting movement (not shown here) on the underlying surface U. Finally, the outwardly disposed narrow sides 14 of the abutment projections can serve as abutments to prevent a lateral lifting movement (not shown here) on the underlying surface U or the like. In all situations the cutting region is limited, in which case the cutting region B shown in FIG. 2 relates to being limited by the inner narrow sides 14 of the projections 12. As can be seen from FIG. 2, the guide plate covers the cutting edge S of the blade K from below in its edge regions.

It is apparent from the plan views in FIGS. 2 and 3 that the guide plate 7, except for the abutment projections 12, is adapted to the profile of the blade head 2 so that the guide plate 7 does not form any impediment in terms of handling the bladed scraper 1. What is also noticeable is a T-shaped opening in the guide plate 7, which is in the form of a through pivotal opening 15 and through which an upper holding portion 16 of the blade receiving means 3 is pivotable, wherein the pivotal movement of the upper holding portion 16 in relation to a lower holding portion 17 for opening and closing the blade receiving means 3 is described in detail in DE 10 2005 059 016 to which reference is directed here. In addition, provided in the guide plate 7 are two lateral engagement openings 18 for lateral manual engagement into the opened blade receiving means 3 for removal or insertion of the blade K, in which respect the blade receiving means 3 is not shown opened in any of FIGS. 1, 2, 5 and 6. Overall the guide plate 7 is of a mirror image-symmetrical configuration with its longitudinal axis 1 as the mirror axis, which simplifies manufacture thereof.

In the second embodiment of the bladed scraper 1 shown in FIGS. 5 and 6 the guide 6 is of a completely different structure from that in the first embodiment and in addition performs further tasks for guiding the bladed scraper 1. In this case, provided in each longitudinal side region 19 of the blade head 2 are two respective guide projections, a guide projection 20 which is a front guide projection in the cutting direction s and a guide projection 21 which is a rear guide projection in the cutting direction s, the projections being arranged in aligned relationship in the cutting direction s and thus overall providing a skid 22. The narrow configuration of the guide projections 20, 21 and their relative position with respect to each other can be clearly seen in FIGS. 8a and b in a plan view thereof. The guide projections 19, 20 are also arranged in aligned relationship perpendicularly to the cutting direction s. The skids 22 or guide projections 20, 21 have at the underside an attack surface 23 with which the guide 6 and by way of the guide 6 the blade head 2 are supported on the underlying surface U shown in FIGS. 5 and 6. As a consequence of the skid shape, the respective attack surface 23 is correspondingly narrow and elongated in the cutting direction s and thus, as in the case of an ordinary slide carriage, provides for guidance of the bladed scraper 1 in the cutting direction s.

As will be directly apparent from the illustrated view and by analogy with the foregoing description, the guide projections 20, 21 can serve as an abutment, like the abutment projections 12 of the first embodiment of the bladed scraper 1, and thus limit the cutting region in the cutting direction s and perpendicularly to the cutting direction s. At the same time the guide projections 20, 21, with their attack surface 23, establish a given positioning of the bladed scraper 1 on the underlying surface U, which also determines the relative position of the blade K with its working cutting edge S. The attack surface 23 is arranged at an attack angle β, which is here fixed, relative to the blade K or a contact surface 24 against which the blade K bears in the blade receiving means 3. The attack angle β is here by way of example 40°.

As indicated in the drawing the blade K, in its working position shown here, is elastically bent about a bending axis b parallel to the working side 5, so that in the working position, its working cutting edge S is arranged at a shallower angle relative to the attack surface 23 than the contact surface 24 and bears more firmly and in more defined relationship against the underlying surface U. In addition a resistance to buckling of the blade or the working cutting edge S, perpendicularly to the cutting direction s, is increased so that the working cutting edge S can engage in a straight line and can permit a smooth flat cut. When the bladed scraper 1 is lifted off, which is not shown here, the blade K is relieved of load and the elastic bending is relieved, that is to say the blade K is flat again and is in a readiness position as described hereinbefore. A projecting portion of the blade K, with which the blade projects beyond the attack surface 23 in its readiness position, provides for determining on the one hand the thickness of a cut-off shaving (not shown here) and/or the flexing of the blade K. In the embodiments illustrated here, the projecting portion is not variable, it can however be variable by way of suitable precautionary measures, as for example in the case of a wood plane.

The guide projections 20, 21 are screwed to the blade head 2 at the top side and the underside respectively, suitable screw holes 8 being provided on the guide projections 20, 21. To permit pivotal movement of the upper holding portion 16, which is unimpeded by the guide projections 20, 21, the rear guide projection 21 which engages over the upper holding portion 16 has a recess 25 in which the upper holding portion 16 is pivotable.

In the third embodiment of the bladed scraper 1 which is shown in a highly diagrammatic view in FIGS. 9 and 10 and in such a way as to reproduce only an underlying principle, the bladed scraper 1 has a body 26 with the blade head 2 and two longitudinal bearers 27. In addition the guide 6 has a rolling device 28 comprising four rolling bodies 29 which are rollable in the cutting direction s and which are here in the form of wheels and which have running surfaces 30 for support and displacement of the bladed scraper 1 on the underlying surface U in and in opposite relationship to the cutting direction s. The running surfaces 30 project beyond the bladed scraper 1 at the underside in a rolling position which is illustrated here. In this case, a rolling body 29 is arranged on each longitudinal bearer 26 in leading relationship in the cutting direction s and a rolling body 29 is arranged thereon in trailing relationship in the cutting direction s, relative to the working side 5. The rolling bodies 29 are arranged in each case as far outwardly as possible and rotatably on a longitudinal bearer 27, in and in opposite relationship to the cutting direction s respectively, so that the bladed scraper 1 which is thus in the form of a carriage can bear against the underlying surface U as widely and stably as possible. For the sake of greater clarity of the drawing, the front longitudinal bearer which is shown as a side view, with both rolling bodies, is omitted from FIG. 9. The longitudinal bearers 27 are screwed to the blade head 2, as is not explicitly shown here. Accordingly this embodiment of the blade scraper 1, with its substantially prismatic body 26 and the simple longitudinal bearers 27, is particularly simple to manufacture.

In this embodiment, the blade head 2 has two blade receiving means, a blade receiving means 31 which is a front receiving means in the illustrated cutting direction s and a blade receiving means 32 which is a rear receiving means in the illustrated cutting direction, the blade receiving means each being arranged at a different attack angle β₁, β₂, relative to the underlying surface U or the attack surface 23, the surface 23 being formed by contact placement points 33 of the rolling bodies 29.

The blade K which is to be used is fitted in the rear blade receiving means 32, wherein the working cutting edge S thereof faces in the cutting direction s, while fitted in the front blade receiving means 31 is a blade which serves as a waiting blade K′ and the working cutting edge S of which faces in opposite relationship to the cutting direction s. The two blades K, K′ are fixed in their respective blade receiving means 31, 32 by way of a holding device which is here indicated by a sheet metal strip 34. It is provided in relation to both blades K, K′ that they flex when the bladed scraper 1 is applied to the underlying surface U to be worked. Thus, firstly a thicker shaving can be planed off the underlying surface U by way of the larger attack angle β₁ of the rear blade receiving means. Upon a reversal in the cutting direction s, the waiting blade K′ can come into operation, which by virtue of its smaller attack angle β₂ can plane off a finer shaving (not shown here) from the underlying surface U and in that way can smooth it.

The two longitudinal bearers 27 and the top side of the body 26 are at the same time a handle H. The two blades K, K′ are formed with two cutting edges, the working cutting edge S and a substitute cutting edge S′, the substitute cutting edge S′ being arranged in a protected condition in the receiving space 4. By rotation of the blade K, K′, the substitute cutting edge S′ which is then used as a working cutting edge is arranged outwardly while the working cutting edge S is arranged in the receiving space 4.

### LIST OF REFERENCES

1 bladed scraper
2 blade head
3 blade receiving means
4 receiving space
5 working side
6 guide
7 guide plate
8 screw
9 screw hole
10 connecting surface
11 abutment device
12 abutment projection
13 notch
14 narrow side
15 pivotal through opening
16 upper holding portion
17 lower holding portion
18 engagement opening
19 longitudinal side region
20 front guide projection
21 rear guide projection
22 skid
23 attack surface
24 contact surface
25 recess
26 body
27 longitudinal bearer
28 rolling device
29 rolling body
30 running surface
31 front blade receiving means
32 rear blade receiving means
33 contact placement point
34 sheet metal strip
β attack angle
β₁ attack angle
β₂ attack angle
B cutting region
K blade
K′ waiting blade
S working cutting edge
S′ substitute cutting edge
H handle
b bending axis
I longitudinal axis
s cutting direction

What is claimed is:

1. A bladed scraper having a blade head including a blade receiving means having a receiving space for a blade for cutting an item to be cut in a cutting direction (s), wherein the blade receiving means has a working side from which the blade projects out of the blade receiving means in a working position with a working cutting edge (S) which comes into use, characterised in that the bladed scraper has a guide for limiting a cutting movement or cutting region (B) of the bladed scraper and/or for positioning the blade head at an attack angle (β, β₁, β₂) or in an attack angle range and that the guide is connected to the bladed scraper.

2. A bladed scraper as set forth in claim 1 characterised in that the guide is adapted to limit the cutting region (B) perpendicularly to the cutting direction (s).

3. A bladed scraper as set forth in claim 2 characterised in that the guide has an abutment device with at least one respective lateral abutment at both longitudinal sides of the receiving means.

4. A bladed scraper as set forth in claim 3 characterised in that the abutment device has a guide plate with abutment projections as abutments, which project in the longitudinal direction of the bladed scraper beyond the working cutting edge (S) and laterally delimit a U-shaped notch in the guide plate, wherein the notch in the position of installation of the guide plate in the bladed scraper extends in opposite relationship to the cutting direction (s) at least approximately to the working side.

5. A bladed scraper as set forth in claim 3 characterised in that the abutment device covers over the working cutting edge (S) in the lateral end regions thereof from above and/or from below and/or laterally.

6. A bladed scraper as set forth in claim 1 characterised in that the working side extends perpendicularly or inclinedly relative to the cutting direction (s).

7. A bladed scraper as set forth in claim 1 characterised in that the guide is arranged at the underside on the bladed scraper.

8. A bladed scraper as set forth in claim 1 characterised in that the guide has an attack positioning device for positioning the blade head at an attack angle (β) or in an attack angle range.

9. A bladed scraper as set forth in claim 8 characterised in that the blade receiving means has a larger side surface in the form of a contact surface for contact in respect of a larger side surface of the blade (K), the contact surface is arranged at an attack angle (β) which opens in the cutting direction (S) in relation to an underside attack surface for positioning or contact of the bladed scraper on a surface to be worked of an underlying material (U), wherein the attack surface extends in the cutting direction (s) and parallel to the working side and the attack angle (β) is an acute angle.

10. A bladed scraper as set forth in claim 9 characterised in that the attack angle (β) is adjustable.

11. A bladed scraper as set forth in claim 9 characterised in that the attack positioning device includes at least one downwardly extending guide projection which has the attack surface at its end.

12. A bladed scraper as set forth in claim 11 characterised in that provided at both longitudinal side regions of the blade head is a respective lateral guide projection which is in the form of a skid and has a narrow underside attack surface extending longitudinally in the cutting direction (S), wherein both lateral guide projections are oriented in mutually parallel relationship.

13. A bladed scraper as set forth in claim 12 characterised in that both lateral guide projections are arranged at least with a portion which is a rear portion in the cutting direction (s), in leading relationship with the working cutting edge (S).

14. A bladed scraper as set forth in claim 1 characterised in that the guide includes a rolling device with a rolling body which is rollable in the cutting direction (s) and which has running surfaces for support and displacement of the bladed scraper on an underlying surface (U) in and in opposite relationship to the cutting direction (s).

15. A bladed scraper as set forth in claim 14 characterised in that there are provided at least four rolling bodies, wherein arranged in each longitudinal side region is a rolling body in leading relationship in the cutting direction (s) with respect to the working cutting edge (S) and a rolling body in trailing relationship in the cutting direction (s) in relation to the working cutting edge (S).

16. (canceled)

17. A bladed scraper as set forth in claim 14 characterised in that the rolling bodies are in the form of rotational cylinders.

18. A bladed scraper as set forth in claim 1 with the blade arranged in the receiving means in a readiness position, characterised in that the blade (K) in a readiness position projects downwardly by a distance beyond the guide with its working cutting edge (S).

19. A bladed scraper as set forth in claim 18 characterised in that the distance is adjustable.

20. A bladed scraper as set forth in claim 18 characterised in that the blade (K) can be moved into a working position with placement of the blade head on an underlying surface and is bendable about an axis parallel to the working side.

21. A bladed scraper as set forth in claim 1 characterised in that the blade head has two blade receiving means for a respective blade (K, K′), wherein the blade (K) in use in a blade receiving means faces with its working cutting edge (S) in the cutting direction (s) and the other blade serving as a waiting blade (K′) in the other blade receiving means faces with its working cutting edge (S) in opposite relationship to the cutting direction (s).

22. A bladed scraper as set forth in claim 21 characterised in that the blade (K) in use is mounted at an attack angle (β₁) different from the attack angle (β₂) of the waiting blade (K′).
